(19) United States
(12) Patent Application Publication
(10) Pub. No.: US 2015/0326678 A1
(43) Pub. Date: Nov. 12, 2015

(54) METHOD FOR RECOMMENDING MESSENGER FRIEND

(71) Applicants: SMART COMZ CO., LTD., Seoul (KR); INNOSPARK INC., Seoul (KR)

(72) Inventors: Euddeum JOO, Seoul (KR); Jaechan SHIN, Seongnam-si, Gyeonggi-do (KR)

(21) Appl. No.: 14/409,471

(22) PCT Filed: Jun. 19, 2013
(86) PCT No.: PCT/KR2013/005417

§ 371 Date: Dec. 19, 2014

(30) Foreign Application Priority Data
Jun. 21, 2012 (KR) 10-2012-0067024

(51) Int. Cl. H04L 29/08; H04L 12/58

(52) U.S. Cl. CPC H04L 67/22; H04L 51/32

(57) ABSTRACT

A method for recommending a messenger friend is disclosed. The method includes receiving at least one first contact number from a first-user terminal through a transceiver by a service server, receiving at least one second contact number from at least one second-user terminal through the transceiver by the service server, comparing the at least one first contact number with the at least one second contact number by a controller of the service server, and recommending, in the presence of the same contact number between the at least one first contact number and the at least one second contact number, the at least one second-user terminal as a friend to the first-user terminal.

### TECHNICAL FIELD

The present invention relates to a method for recommending a messenger friend, and more particularly, to a method for recommending a messenger friend, in which a third-user terminal is detected and recommended as a friend to a terminal of a messenger user.

### BACKGROUND ART

Owing to the reinforcement of network infrastructure, the widespread use of the Internet, and the development of mobile communication technology, a communication service is accessible irrespective of time and place. This change has brought a significant increase in efficiency and convenience to business and daily living. Further, the convenient accessibility of communication service has greatly changed the way people establish their social relationships and interact with each other.

For example, a Social Networking Service (SNS) enables individuals to establish relationships with unspecified others in various manners through their terminals capable of connecting to a communication network. The individuals build new relationships or strengthen their existing relationships through the SNS.

A messenger is a service in which individuals access a communication network and exchange messages and data with unspecified others through a messenger application installed in their portable terminals or the like. The individuals also build new relationships or strengthen their existing relationships through the messenger.

A server that manages an SNS or a messenger service has a specific algorithm of recommending friends to users connected to the service. Algorithms that recommend more friends to users more reliably are under development.

### DISCLOSURE

### Technical Problem

An object of the present invention devised to solve the conventional problem is to provide a method for recommending more friends to a user reliably by searching for a third terminal based on a contact number received from a terminal matching a contact number stored in a terminal of a user and recommending the detected third terminal as a friend to the terminal of the user.

It will be appreciated by persons skilled in the art that the objects that could be achieved with the present invention are not limited to what has been particularly described hereinabove and the above and other objects that the present invention could achieve will be more clearly understood from the following detailed description.

### Technical Solution

In an aspect of the present invention, a method for recommending a messenger friend includes receiving at least one first contact number from a first-user terminal through a transceiver by a service server, searching for at least one second contact number received from at least one second-user terminal matching the at least one first contact number by a controller of the service server, searching for at least one third-user terminal matching the at least one second contact number by the controller of the service server, and recommending the at least one detected third-user terminal to the first-user terminal by the controller of the service server.

The searching of at least one second contact number includes receiving information about a specific recommender terminal selected from the at least one second-user terminal from the first-user terminal by the service server and searching for a third-user terminal matching a contact number received from the recommender terminal by the controller.

The searching of a third-user terminal matching a contact number received from the recommender terminal includes excluding at least one second contact number received from a remaining second-user terminal unselected as a recommender terminal from search targets.

The searching and recommending of the at least one detected third-user terminal to the first-user terminal includes, if a contact number corresponding to the first user-terminal is stored in a third-user terminal, recommending the third-user terminal as an old friend to the first-user terminal by the controller.

The searching and recommending of the at least one detected third-user terminal to the first-user terminal includes, if a contact number corresponding to the first user-terminal is not stored in a third-user terminal, recommending the third-user terminal as a new friend to the first-user terminal by the controller.

The method may further include information about a predetermined number of recommended terminals selected from the at least one contact number or the at least one second contact number from the first-user terminal or the at least one second-user terminal by the service server.

The method may further include quantifying communication records of the first-user terminal and prioritizing the at least one third-user terminal according to the score.

The communication records may include at least one of a voice or video call time, the number of text message transmissions, or the number of file transmissions between the first-user terminal and the at least one third-user terminal.

Upon receipt of user information from the first-user terminal, the at least one second-user terminal, and the at least one third-user terminal, the service server may offer points to the first-user terminal, the at least one second-user terminal, and the at least one third-user terminal, for use in a messenger service.

The user information may include at least one of a name, an age, an email address, or a SNS Identifier (ID) of a user.

In another aspect of the present invention, a method for recommending a messenger friend includes receiving at least one first contact number from a first-user terminal through a transceiver by a service server, receiving at least one second contact number from at least one second-user terminal through the transceiver by the service server, comparing the at least one first contact number with the at least one second contact number by a controller of the service server, and recommending, in the presence of the same contact number between the at least one first contact number and the at least one second contact number, the at least one second-user terminal as a friend to the first-user terminal.

The recommendation may include quantifying an access time of the at least one second-user terminal to the service server as a score and prioritizing the at least one second-user terminal according to the score, for recommendation as a friend to the first-user terminal.

The controller may set a lower score for the at least one second-user terminal, as the at least one second-user terminal connects to the service server for a shorter time period.

The controller may recommend a second-user terminal having a lower score to the first-user terminal, with priority.

The recommendation may include receiving information about a recommendation time interval for recommendation of the at least one second-user terminal from the first-user terminal by the service server, and recommending a second-user terminal at every time interval based on the recommendation time interval to the first-user terminal by the controller.

The recommendation may include recommending a second-user terminal only at the moment the first-user terminal connects to the service server by the controller.

The method may further include receiving information about a favorable terminal selected from the at least one recommended second-user terminal from the first-user terminal by the service server.

The service server may transmit a notification message to the favorable terminal.

Upon receipt of user information from the first-user terminal and the at least one second-user terminal, the service server may offer points to the first-user terminal and the at least one second-user terminal, for use in the messenger service.

The user information may include at least one of a name, an age, an email address, or a SNS ID of a user.

### Advantageous Effects

In the method for recommending a messenger friend according to the present invention, as third-user terminals matching second contact numbers stored in second user-terminals that match contact numbers stored in a first-user terminal is recommended as friends to the first-user terminal, a large number of friends can be recommended reliably to the first-user terminal.

It will be appreciated by persons skilled in the art that that the effects that can be achieved through the present invention are not limited to what has been particularly described hereinabove and other advantages of the present invention will be more clearly understood from the following detailed description.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 is a view of a system for performing a method for recommending a messenger friend according to the present invention;

FIG. 2 is a block diagram of a device that is applicable as a service server illustrated in FIG. 1 and that is capable of implementing the present invention;

FIG. 3 is a flowchart illustrating a method for recommending a messenger friend according to an embodiment of the present invention;

FIG. 4 illustrates screens on which user information is input in a messenger service according to an embodiment of the present invention;

FIG. 5 is a flowchart illustrating a method for recommending a messenger friend according to another embodiment of the present invention; and

FIG. 6 illustrates screens on which interest in a recommended friend is expressed in a messenger service according to an embodiment of the present invention.

### BEST MODE FOR CARRYING OUT THE INVENTION

The objectives and effects of the present invention and the technical configurations of the present invention to achieve them will be apparent with reference to embodiments of the present invention described in detail with the attached drawings. A detailed description of a generally known function and structure of the present invention will be avoided lest it should obscure the subject matter of the present invention. Although the terms used in the present invention are selected from generally known and used terms, taking into account the structures, roles, and functions of the present invention, they are subject to change depending on the intention of a user or an operator or practices.

It is to be clearly understood that the present invention may be implemented in various manners, not limited to embodiments as set forth herein. The embodiments of the present invention are provided only to render the disclosure of the present invention comprehensive and indicate the scope of the present invention to those skilled in the art. The present invention is defined only by the appended claims. Accordingly, the scope of the invention should be determined by the overall description of the specification.

Through the specification, when it is said that some part “includes” a specific element, this means that the part may further include other elements, not excluding them, unless otherwise mentioned. The terms “unit”, “part” and “module” used herein indicate a unit that executes at least one function or operation and may be implemented in hardware, software, or both.

In embodiments of the present invention, each component, function block, or means may be configured with one or more sub-components. Electrical, electronic, and mechanical functions performed by each component may be implemented into various known devices or mechanical elements such as electronic circuits, integrated circuits, or Application Specific Integrated Circuits (ASICs). Components may be configured separately or two or more components may be incorporated into a single component.

It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus, such that the instructions, which execute via the processor of the computer or other programmable data processing apparatus, create means for implementing the functions/acts specified in the flowchart and/or block diagram block or blocks. These computer program instructions may also be stored in a computer usable medium or computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

In addition, each block or each step may represent a part of a module, segment, or code that contains one or more executable instructions to execute a specific logical function(s). It is to be noted that functions mentioned in blocks or steps take place in a different order in some alternative embodiments. For example, two consecutive blocks or steps may be performed substantially at the same or in reverse order depending on corresponding functions.

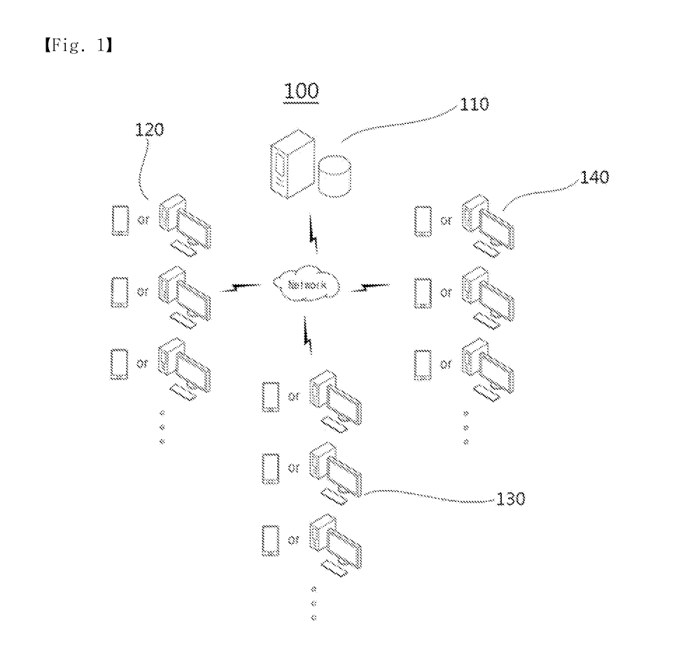

FIG. 1 is a view of a system 100 for performing a method for recommending a messenger friend according to the present invention.

Referring to FIG. 1, the system 100 for performing the method for recommending a messenger friend according to the present invention includes a messenger friend recommender 110, terminals 120 of first users (hereinafter, referred to as first-user terminals 120), terminals 130 of second users (hereinafter, referred to as second-user terminals 130), and terminals 140 of third users (hereinafter, referred to as third-user terminals 140). The messenger friend recommender 110, the first-user terminals 120, the second-user terminals 130, and the third-user terminals 140 may transmit and receive data and contact numbers with one another through a network.

The messenger friend recommender 110 may be a service server that recommends third-user terminals 140 as friends to a first-user terminal 120 in a messenger service according to the present invention. In this context, the messenger friend recommender 110 will be referred to as a service server 110, for the convenience of description.

The service server 110 may implement a messenger service that enables users to transmit and receive instant messages and a friend recommendation service that enables friend recommendation in a messenger through an Internet server or the like. Further, the service server 110 may provide the friend recommendation service to the first-user terminals 120, the second-user terminals 130, and the third-user terminals 140 that are connected to the messenger service.

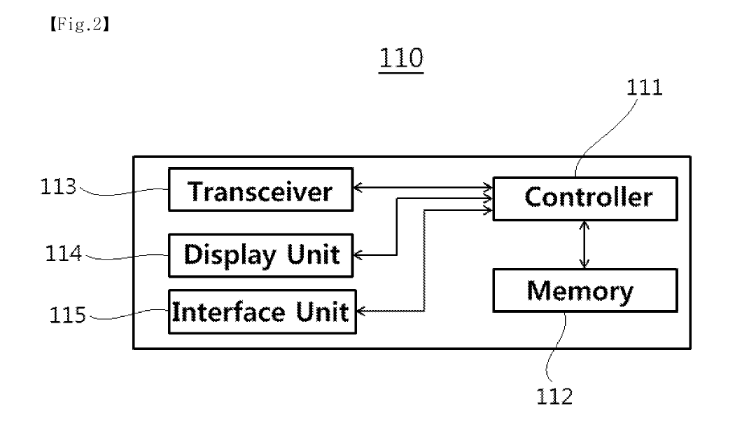

FIG. 2 is a block diagram of a device that is applicable as the service server 110 illustrated in FIG. 1 and that is capable of implementing the present invention.

Referring to FIG. 2, the service server 110 may include a controller 111, a memory 112, a transceiver 113, a display unit 114, and an interface unit 115.

The controller 111 may provide overall control to the service server 110.

The memory 112 may be electrically connected to the controller 111 and may store an Operating System (OS), an application program, and data.

The transceiver 113 may be electrically connected to the controller 111 and may transmit or receive data to or from the first-user terminals 120, the second-user terminals 130, and the third-user terminals 140.

The display unit 114 may display various types of information in electrical connection to the controller 111 and may be configured with a known Liquid Crystal Display (LCD), an Organic Light Emitting Diode (OLED) display, or the like.

The interface unit 115 may be electrically connected to the controller 111 and may be combined with a known interface unit such as a keyboard, a touch screen, or the like.

The first-user terminals 120, the second-user terminals 130, and the third-user terminals 140 are devices used by the users that are connected to the messenger service of the service server 110 and receive the messenger service to exchange instant messages with their acquaintances. The first-user terminals 120, the second-user terminals 130, and the third-user terminals 140 may be, but not limited to, computers or smartphones.

The first-user terminals 120, the second-user terminals 130, and the third-user terminals 140 may download a specific program in the messenger service provided by the service server 110, install the downloaded program, and receive the messenger service and the friend recommendation service from the service server 110 by executing the installed program.

Alternatively or additionally, the first-user terminals 120, the second-user terminals 130, and the third-user terminals 140 may receive the messenger service and the friend recommendation service from the service server 110 by connecting to the messenger service through a network without installing an additional program.

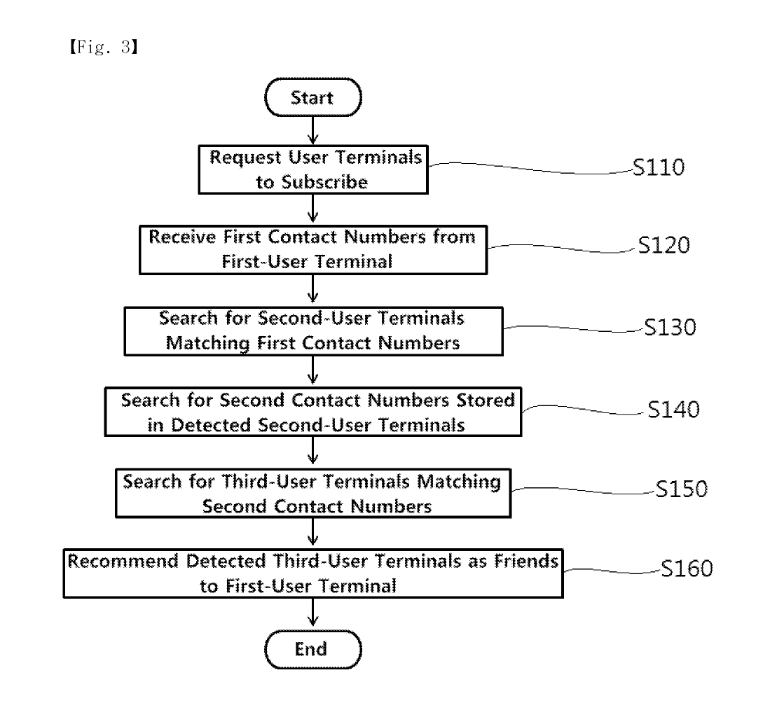

Now, a detailed description will be given of a method for recommending third-user terminals 140 as friends to a first-user terminal 120 by the service server 110, with reference to FIG. 3. FIG. 3 is a flowchart illustrating a method for recommending a messenger friend according to an embodiment of the present invention. For the convenience of description, the following description is given with the appreciation that the first-user terminals 120, the second-user terminals 130, and the third-user terminals 140 are smartphones.

Referring to FIG. 3, the service server 110 requests the first-user terminals 120, the second-user terminals 130, and the third-user terminals 140 to subscribe to the messenger service (S110). When subscribing to the messenger service, the first-user terminals 120, the second-user terminals 130, and the third-user terminals 140 may transmit their user information to the service server 110.

The service server 110 may offer points for the messenger service to the first-user terminals 120, the second-user terminals 130, and the third-user terminals 140 depending on how much of user information is to be input or transmitted.

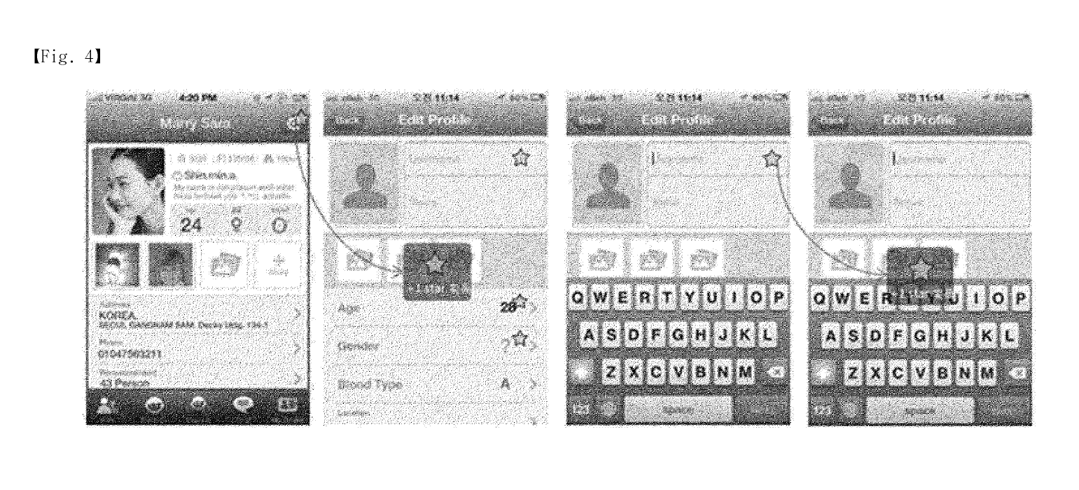

For example, upon receipt of a name of a first user from a first-user terminal 120, the service server 120 may offer points to the first-user terminal 120, for use in the messenger service (see FIG. 4).

Or upon receipt of the age of the first user from the first-user terminal 120, the service server 120 may offer points to the first-user terminal 120, for use in the messenger service (see FIG. 4).

Or upon receipt of an e-mail address or SNS Identifier (ID) of the first user from the first-user terminal 120, the service server 120 may offer points to the first-user terminal 120, for use in the messenger service.

Accordingly, the service server 110 may easily acquire the user information from the first-user terminals 120, the second-user terminals 130, and the third-user terminals 140 that subscribe to the messenger service.

The user information may be phone numbers corresponding to the first-user terminals 120, the second-user terminals 130, and the third-user terminals 140. The controller 111 of the service server 110 may build a database with the phone numbers corresponding to the first-user terminals 120, the second-user terminals 130, and the third-user terminals 140 and store the database in the memory 112.

The service server 110 receives first contact numbers from a first-user terminal 120 through the transceiver 113 (S120). The first contact numbers are contact numbers of acquaintances of a first user corresponding to the first-user terminal 120. The contact numbers may be, but not limited to, phone numbers, e-mail addresses, or SNS Identifiers (IDs).

The controller 111 of the service server 110 searches for a plurality of second-user terminals 130 that have transmitted phone numbers matching the first contact numbers by comparing the first contact numbers with phone numbers of the second-user terminals 130 stored in the database (S130).

Specifically, when the first-user terminal 120 subscribes to the messenger service, the controller 111 of the service server 110 may request the first contact numbers to the first-user terminal 120, store the first contact numbers received from the first-user terminal 120 in the memory 112, and search for a plurality of second-user terminals 130 that have transmitted the phone numbers matching the first contact numbers.

Or each time the first-user terminal 120 accesses the messenger service, the controller 111 of the service server 110 may receive first contact numbers from the first-user terminal 120, and search for a plurality of second-user terminals 130 that have transmitted the phone numbers matching the first contact numbers.

The service server 110 searches for second contact numbers stored in the plurality of detected second-user terminals 130 (S140). When the second-user terminals 130 subscribe to the messenger service, the controller 111 of the service server 110 may request the second contact numbers to the second-user terminals 130, store the second contact numbers in the memory 112, and then search for the second contact numbers. Or each time the second-user terminals 130 access the messenger service, the controller 111 of the service server 110 may receive second contact numbers and then search for the second contact numbers.

The controller 111 of the service server 110 searches for a plurality of third-user terminals 140 that have transmitted phone numbers matching the second contact numbers by comparing the second contact numbers with phone numbers of the third-user terminals 140 stored in the database (S150).

The controller 111 of the service server 110 recommends the plurality of third-user terminals 140 that have transmitted the phone numbers matching the second contact numbers, as friends to the first-user terminal 120 (S160).

If a third-user terminal 140 has a phone number of the first-user terminal 120, the controller 111 may recommend the third-user terminal 140 as an old friend to the first-user terminal 120.

On the other hand, if a third-user terminal 140 does not have a phone number of the first-user terminal 120, the controller 111 may recommend the third-user terminal 140 as a new friend to the first-user terminal 120.

As the service server 110 recommends the third-user terminals 140 matching the second contact numbers received from the second-user terminals 130 as friends to the first-user terminal 120, the service server 110 may provide a highly reliable friend recommendation service.

In the messenger service, the service server 110 may provide a screen on which a second-user terminal 130 may select a predetermined number of recommended terminals from among a plurality of third-user terminals 140 matching second contact numbers stored in the second-user terminal 130.

The service server 110 may receive information about the selected recommended terminals from the second-user terminal 130. The controller 111 of the service server 110 may recommend only the selected recommended terminals as friends to the first-user terminal 120.

Thus, the controller 111 of the service server 110 may prevent unselected third-user terminals 140 from being recommended as friends to the first-user terminal 120.

In this manner, the service server 110 may recommend only persons selected by the second users using the second-user terminals 130 as friends to the first user using the first-user terminal 120. Thus friend recommendation is efficient.

Further, the service server 110 may provide a screen on which the first-user terminal 120 selects, as recommenders, a predetermined number of second-user terminals 130 from among the detected second-user terminals 130 in the messenger service.

The service server 110 may receive information about the recommender terminals selected by the first-user terminal 120. The controller 111 of the service server 110 may detect third-user terminals 140 matching second contact numbers received from the recommender terminals and recommend the detected third-user terminals 140 as friends to the first-user terminal 120.

Thus, the controller 111 of the service server 110 may exclude third-user terminals 140 that match second contact numbers received from the other second-user terminals 130 but are not selected as recommender terminals, from search targets.

As the first user using the first-user terminal 120 selects a recommender terminal on his or her own and thus third-user terminals 140 matching contact numbers stored in the recommender terminal are recommended to the first user, the service server 110 may provide a highly satisfactory friend recommendation service.

The controller 111 of the service server 110 may quantify, as scores, communication records between the first-user terminal 120 and the third-user terminals 140. The communication records may include, but not limited to, at least one of voice or video call times, the numbers of text message transmissions, and the numbers of file transmissions between the first-user terminal 120 and the third-user terminals 140.

The controller 111 may quantify the communication records and prioritize the third-user terminals 140 accordingly.

For example, if the first-user terminal 120 has communicated with a third-user terminal 140 for a longer time, the communication time may be scored higher. The controller 111 may recommend a third-user terminal 140 having the highest score to the first-user terminal 120 with priority. Accordingly, the service server 110 may provide a highly reliable friend recommendation service by recommending third-user terminals 140 that have communicated for longer as friends to the first-user terminal 120.

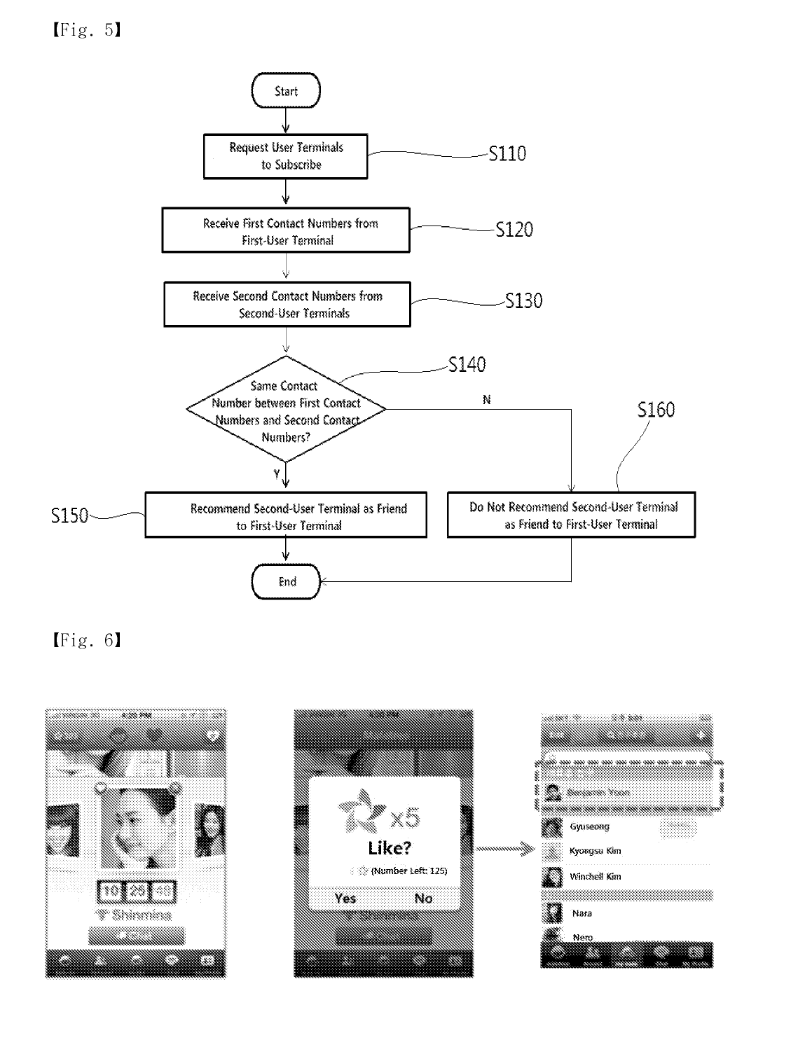

With reference to FIG. 5, a method for recommending third-user terminals 140 as friends to a first-user terminal 120 by the service server 110 according to another embodiment of the present invention will be described. FIG. 5 is a flowchart illustrating a method for recommending a messenger friend according to another embodiment of the present invention. For the convenience of description, the following description is given with the appreciation that the first-user terminals 120, the second-user terminals 130, and the third-user terminals 140 are smartphones.

Referring to FIG. 5, the service server 110 requests the first-user terminals 120, the second-user terminals 130, and the third-user terminals 140 to subscribe to the messenger service (S110). When subscribing to the messenger service, the first-user terminals 120, the second-user terminals 130, and the third-user terminals 140 may transmit their user information to the service server 110.

The user information may be phone numbers corresponding to the first-user terminals 120, the second-user terminals 130, and the third-user terminals 140. Or the user information may be, but not limited to, e-mail addresses or SNS IDs corresponding to the first-user terminals 120, the second-user terminals 130, and the third-user terminals 140.

The controller 111 of the service server 110 may build a database with the phone numbers, e-mail addresses, or SNS IDs corresponding to the first-user terminals 120, the second-user terminals 130, and the third-user terminals 140 and store the database in the memory 112.

The service server 110 receives first contact numbers from the first-user terminal 120 through the transceiver 113 (S120). The first contact numbers are contact numbers of acquaintances of a first user using the first-user terminal 120. The first contact numbers may be, but not limited to, phone numbers, e-mail addresses, or SNS IDs.

The service server 110 receives second contact numbers from second-user terminals 120 through the transceiver 113 (S130). The second contact numbers are contact numbers of acquaintances of second users using the second-user terminals 130. The second contact numbers may be, but not limited to, phone numbers, e-mail addresses, or SNS IDs.

The controller 111 of the service server 110 compares the first contact numbers with the second contact numbers to detect the same contact numbers between the first contact numbers and the second contact numbers (S140). Specifically, when the first-user terminal 120 and the second-user terminals 130 subscribe to the messenger service, the controller 111 of the service server 110 may request the first contact numbers and the second contact numbers to the first-user terminal 120 and the second-user terminals 130, store the first and second contact numbers in the memory 112, and then compare the first contact numbers with the second contact numbers.

In the presence of the same contact number, the controller 111 of the service server 110 recommends a second-user terminal 130 having the contact number as a friend to the first-user terminal 120 (S150).

The first contact numbers may not include a phone number, an email address, or a SNS ID of a second-user terminal 130 and the second contact numbers may not include a phone number, an email address, or a SNS ID of the first-user terminal 120.

Then, the service server 110 may recommend the second-user terminal 130 whose contact number is not stored in the first-user terminal 120 as a friend to the first-user terminal 120, thereby helping the first user of the first-user terminal 120 to easily build relationships.

On the other hand, in the absence of the same contact number between the first contact numbers of the first-user terminal 120 and the second contact numbers of the second-user terminal 130, the controller 111 of the service server does not recommend the second-user terminal 130 as a friend to the first-user terminal 120 (S160).

When the service server 110 recommends a second-user terminal 130 as a friend to the first-user terminal 120, the controller 111 of the service server 110 may quantify, as scores, time periods over which the second-user terminals 130 are connected to the messenger service and prioritize the second-user terminals 130 accordingly.

For example, the controller 111 may set a lower score for a second-user terminal 130 having a smaller connection time for the messenger service. The controller 111 may recommend a second-user terminal 130 having the lowest score to the first-user terminal 120 with priority.

As the service server 110 recommends a second-user terminal 130 that accesses the messenger service less frequently as a friend to the first-user terminal 120 with priority, the service server 110 may encourage the second-user terminal 130 to connect to the messenger service again.

The service server 110 may provide a screen on which the first-user terminal 120 may select a time for new friend recommendation in the messenger service.

The service server 110 may receive information indicating a recommendation time interval for recommendation of a second-user terminal 130 from the first-user terminal 120. The controller 111 may recommend a second-user terminal 130 to the first-user terminal 120 at every specific time interval based on the recommendation time interval.

On the contrary, if the service server 110 does not receive a recommendation time interval from the first-user terminal 120, the controller 111 may recommend a second-user terminal 130 as a friend to the first-user terminal 120 only at the moment the first-user terminal 120 accesses the messenger service.

As the service server 110 recommends second-user terminals 130 as friends to the first-user terminal 120 accessing the messenger service at specific time intervals, overload of a server managed by the service server 110 may be prevented.

In addition, the service server 110 may provide a screen on which the first-user terminal 120 may select a favorable terminal from among recommended second-user terminals 130 in the messenger service (see FIG. 6).

The first-user terminal 120 may indicate the selected favorable terminal to the service server 110. Then the controller 111 of the service server 110 may detect a second-user terminal 130 selected as the favorable terminal and transmit a notification message to the second-user terminal 130.

In addition, the controller 111 of the service server 110 may display an emoticon or icon representing the favorable terminal selected by the first-user terminal 120 on a screen in the messenger service.

Accordingly, the service server 110 may encourage the second-user terminal 130 to readily connect to the messenger service.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

1-10. (canceled)

11. A method for recommending a messenger friend, the method comprising:
receiving at least one first contact number from a first-user terminal through a transceiver by a service server;
receiving at least one second contact number from at least one second-user terminal through the transceiver by the service server;
comparing the at least one first contact number with the at least one second contact number by a controller of the service server; and
recommending, in the presence of the same contact number between the at least one first contact number and the at least one second contact number, the at least one second-user terminal as a friend to the first-user terminal.

12. The method according to claim 11, wherein the recommendation comprises quantifying an access time of the at least one second-user terminal to the service server as a score and prioritizing the at least one second-user terminal according to the score, for recommendation as a friend to the first-user terminal.

13. The method according to claim 12, wherein the controller sets a lower score for the at least one second-user terminal, as the at least one second-user terminal connects to the service server for a shorter time period.

14. The method according to claim 13, wherein the controller recommends a second-user terminal having a lower score to the first-user terminal, with priority.

15. The method according to claim 11, wherein the recommendation comprises:
receiving information about a recommendation time interval for recommendation of the at least one second-user terminal from the first-user terminal by the service server; and
recommending a second-user terminal at every time interval based on the recommendation time interval to the first-user terminal by the controller.

16. The method according to claim 11, wherein the recommendation comprises recommending a second-user terminal only at the moment the first-user terminal connects to the service server by the controller.

17. The method according to claim 11, further comprising receiving information about a favorable terminal selected from the at least one recommended second-user terminal from the first-user terminal by the service server.

18. The method according to claim 17, wherein the service server transmits a notification message to the favorable terminal.

19. The method according to claim 11, wherein upon receipt of user information from the first-user terminal and the at least one second-user terminal, the service server offers points to the first-user terminal and the at least one second-user terminal, for use in the messenger service.

20. The method according to claim 19, wherein the user information includes at least one of a name, an age, an email address, or a SNS Identifier (ID) of a user.
